(19) United States
(12) Patent Application Publication
(10) Pub. No.: US 2025/0022078 A1
(43) Pub. Date: Jan. 16, 2025

(54) SYSTEM AND METHOD USING A PLURALITY OF GLOBAL POSITIONING SYSTEM DEVICES TO EXECUTE TRAVEL FOR GEOGRAPHICALLY-DIVERSE GROUPS OF TRAVELERS TRAVELING FOR A COMMON PURPOSE

(71) Applicant: Ahmed Shaaban, Hoffman Estates, IL (US)

(72) Inventors: Ahmed Farouk SHAABAN, South Barrington, IL (US); Venkat THANDRA, Chicago, IL (US); Dino ELIOPULOUS, South Barrington, IL (US)

(21) Appl. No.: 18/904,934

(22) Filed: Oct. 2, 2024

Related U.S. Application Data
(63) Continuation of application No. 16/992,380, filed on Aug. 13, 2020.
(60) Provisional application No. 62/887,731, filed on Aug. 16, 2019.
(60) Provisional application No. 62/886,121, filed on Aug. 13, 2019.

(51) Int. Cl. G06Q 50/14; G06F 16/2457; G06F 16/9535; G06F 16/9538; G06N 5/02; G06Q 10/02; G06Q 10/04; G06Q 10/1093; G06Q 30/0226

(52) U.S. Cl. CPC G06Q 50/14; G06F 16/24578; G06F 16/9535; G06F 16/9538; G06N 5/02; G06Q 10/02; G06Q 10/04; G06Q 10/1093; G06Q 30/0226

(57) ABSTRACT

Systems and methods of using a plurality of global positioning system (“GPS”) devices to execute travel for geographically-diverse groups of travelers traveling for a common purpose are disclosed herein. In an embodiment, a method includes reserving a first travel option for a first user departing from a first airport within a predefined first range of the first GPS location at a first time when the first user is available according to a first digital calendar, and when the first user terminal did not arrive at the first airport on the same day prior to first time or the first GPS device was not subsequently disabled, booking a new first travel option for the first user departing from the first airport at a different first time when the first user is available according to the first digital calendar and notify a second user.

### PRIORITY

This patent application is a continuation of U.S. patent application Ser. No. 16/992,380, filed Aug. 13, 2020, entitled “System and Method for Optimizing Group Travel Arrangements for a Constraint-Limited Group,” which claims priority to U.S. Provisional Patent Application No. 62/886,121, filed Aug. 13, 2019, entitled “Travel Coordination Application,” and to U.S. Provisional Application No. 62/887,731, filed Aug. 16, 2019, entitled “System for Travel Arrangements for Constraint-Limited Groups,” the entirety of each of which is incorporated herein by reference and relied upon.

### BACKGROUND

### Technical Field

This disclosure generally relates to a system and method for making travel arrangements. More specifically, the present disclosure relates to a system and method for optimizing travel arrangements for groups of people in constraint-limited scenarios.

### Background Information

Various tools for researching and booking travel arrangements exist. For examples, on-line services like Expedia, Orbitz and Hotels.com allow customers to research flights, hotel availability, and other travel-related products and services. These tools are useful for enabling individual travelers to arrange travel plans.

### SUMMARY

It has been found that the conventional on-line services are not ideally suited for geographically-diverse groups of travelers who are traveling for a common purpose. For example, in certain industries (e.g., law, business consulting, etc.), it is common for individuals from many different regions to meet at a single location. In these situations, it is often the case that each individual makes his or her own travel arrangements while possibly informing other team members of plans and/or finalized arrangements. However, it is typically a time-consuming and tedious task to comply with a company's travel policy, find flights or hotels that satisfy an individual's travel preferences, and communicate with team members to find out their flight and hotel options. While this approach can work in terms of getting team members to the correct location on the designated date, such uncoordinated/loosely coordinated travel planning results in missed opportunities such as synchronized flights arrival times, booking of nearby hotels, and valuable team prep time.

The present disclosure provides tools for optimizing travel arrangements for groups of people in constraint-limited scenarios. A first aspect of the present disclosure is to provide a system for optimizing travel arrangements for groups of people in constraint-limited scenarios. The system comprises a central server including at least a processor and a memory. The central server is configured to communicate with at least (a) a first user terminal configured to accept, from a first user, at least one first user input relating to a group travel event involving the first user and a second user, (b) a second user terminal configured to accept, from the second user, at least one second user input regarding at least one travel preference relating to the group travel event, and (c) a travel search and booking system including information related to a plurality of travel options available to the second user for traveling to the group travel event. The processor is configured to execute instructions stored on the memory to cause the central server to: (i) receive the at least one first user input accepted by the first user terminal and the at least one second user input accepted by the second user terminal; (ii) determine at least one first weighted value using the at least one first user input and at least one second weighted value using the at least one second user input; (iii) calculate a plurality of travel scores for the second user using the at least one first weighted value and the at least one second weighted value, each of the plurality of travel scores corresponding to a respective travel option made available by the travel search and booking system; (iv) enable the second user to select at least the travel option having the highest travel score using the second user terminal; and (v) reserve the travel option having the highest travel score via the travel search and booking system upon selection by the second user.

In accordance with a second aspect of the present disclosure, which can be combined with the first aspect, the at least one first user input includes at least one of: (i) a location of the group travel event; (ii) a date of the group travel event; (iii) a time of the group travel event; and (iv) identification of the second user.

In accordance with a third aspect of the present disclosure, which can be combined with any one or more of the previous aspects, the at least one first weighted value is an average weighted score for a hard constraint, and the at least one second weighted value is an average weighted score for a soft constraint.

In accordance with a fourth aspect of the present disclosure, which can be combined with any one or more of the previous aspects, the at least one first weighted value is a first score for a hard constraint, the at least one second weighted value is a second score for a soft constraint.

In accordance with a fifth aspect of the present disclosure, which can be combined with any one or more of the previous aspects, the processor is configured to calculate a first average weighted score using the at least one first weighted value, and to calculate a second average weighted score using the at least one second weighted value, and the processor is further configured to calculate the plurality of travel scores using the first average weighted score and the second average weighted score.

In accordance with a sixth aspect of the present disclosure, which can be combined with any one or more of the previous aspects, the processor is configured to cause the second user terminal to display a plurality of travel options such that the plurality of travel options are arranged according to respective travel scores.

In accordance with a seventh aspect of the present disclosure, which can be combined with any one or more of the previous aspects, the at least one second user input is automatically accepted from the second user's digital calendar.

In accordance with an eighth aspect of the present disclosure, which can be combined with any one or more of the previous aspects, the system includes at least one of the first user terminal, the second user terminal, and the travel search and booking system.

In accordance with a ninth aspect of the present disclosure, which can be combined with any one or more of the previous aspects, the processor is configured to retrieve at least one third input stored on the memory, calculate at least one third weighted value using the at least one third input, and calculate the plurality of travel scores for the second user using the at least one third weighted value.

In accordance with a tenth aspect of the present disclosure, which can be combined with any one or more of the previous aspects, the at least one second input is received from the second terminal and stored by the memory prior to the first user terminal accepting the at least one first user input relating to the group travel event.

In accordance with an eleventh aspect of the present disclosure, which can be combined with any one or more of the previous aspects, a method of optimizing travel arrangements for groups of people in constraint-limited scenarios includes receiving, from a first user terminal, at least one first user input from a first user relating to a group travel event involving the first user and a second user, receiving, from a second user terminal, at least one second user input from a second user regarding at least one travel preference relating to the group travel event, determining, using a processor in communication with the first user terminal and the second user terminal, at least one first weighted value for the at least one first user input and at least one second weighted value for the at least one second user input, calculating, using the processor, a plurality of travel scores for the second user using the at least one first weighted value and the at least one second weighted value, each of the plurality of travel scores corresponding to a respective travel option for the second user, enabling the second user to select at least the travel option having the highest travel score, and reserving the travel option having the highest travel score upon selection by the second user.

In accordance with a twelfth aspect of the present disclosure, which can be combined with any one or more of the previous aspects, the at least one first user input includes at least one of: (i) a location of the group travel event; (ii) a date of the group travel event; (iii) a time of the group travel event; and (iv) identification of the second user.

In accordance with a thirteenth aspect of the present disclosure, which can be combined with any one or more of the previous aspects, the at least one first weighted value is an average weighted score for a hard constraint, and the at least one second weighted value is an average weighted score for a soft constraint.

In accordance with a fourteenth aspect of the present disclosure, which can be combined with any one or more of the previous aspects, the at least one first weighted value is a first score for a hard constraint, the at least one second weighted value is a second score for a soft constraint.

In accordance with a fifteenth aspect of the present disclosure, which can be combined with any one or more of the previous aspects, enabling the second user to select at least the travel option having the highest travel score includes causing a display of a plurality of travel options to the second user such that the plurality of travel options are arranged according to respective travel scores.

In accordance with a sixteenth aspect of the present disclosure, which can be combined with any one or more of the previous aspects, receiving the at least one second user input from the second user includes automatically receiving the at least one second user input from the second user's digital calendar.

In accordance with a seventeenth aspect of the present disclosure, which can be combined with any one or more of the previous aspects, the method includes calculating a first average weighted score using the at least one first weighted value, calculating a second average weighted score using the at least one second weighted value, and calculating the plurality of travel scores for the second user using the first average weighted score and the second average weighted score.

In accordance with an eighteenth aspect of the present disclosure, which can be combined with any one or more of the previous aspects, a method of optimizing travel arrangements for groups of people in constraint-limited scenarios includes receiving, from a first user terminal, at least one first user input from a first user relating to a group travel event involving the first user and a second user, receiving, from a second user terminal, at least one second user input from a second user regarding at least one travel preference relating to the group travel event, calculating, using a processor in communication with the first user terminal and the second user terminal, a plurality of travel scores for the second user using the at least one first user input and the at least one second user input, each of the plurality of travel scores corresponding to a respective travel option made available by a travel search and booking system, and reserving the travel option having the highest travel score.

In accordance with a nineteenth aspect of the present disclosure, which can be combined with any one or more of the previous aspects, calculating the plurality of travel scores includes determining at least one first value based on the at least one first user input, determining at least one second value based on the at least one second user input, and using the at least one first value and the at least one second value in a calculation of at least one of the plurality of travel scores

In accordance with a twentieth aspect of the present disclosure, which can be combined with any one or more of the previous aspects, a system includes a processor and a memory, the processor configured to execute instructions stored on the memory to perform the methods discussed herein.

### BRIEF DESCRIPTION OF THE DRAWINGS

Referring now to the attached drawings which form a part of this original disclosure:

FIG. 1 illustrates an example embodiment of a system for optimizing travel arrangements for groups of people in constraint-limited scenarios in accordance with the present disclosure;

FIG. 2 illustrates a representative diagram of an example embodiment of a user terminal which can be used in the system of FIG. 1;

FIG. 3 illustrates a representative diagram of the system for optimizing travel arrangements shown in FIG. 1;

FIG. 4 illustrates an example embodiment of a method for optimizing travel arrangements in accordance with the present disclosure;

FIG. 5 illustrates an example embodiment of a method for optimizing travel arrangements in accordance with the present disclosure; and

FIGS. 6 to 10 illustrate example embodiments of graphical user interfaces that can be displayed to a user during the methods of FIGS. 4 and 5.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

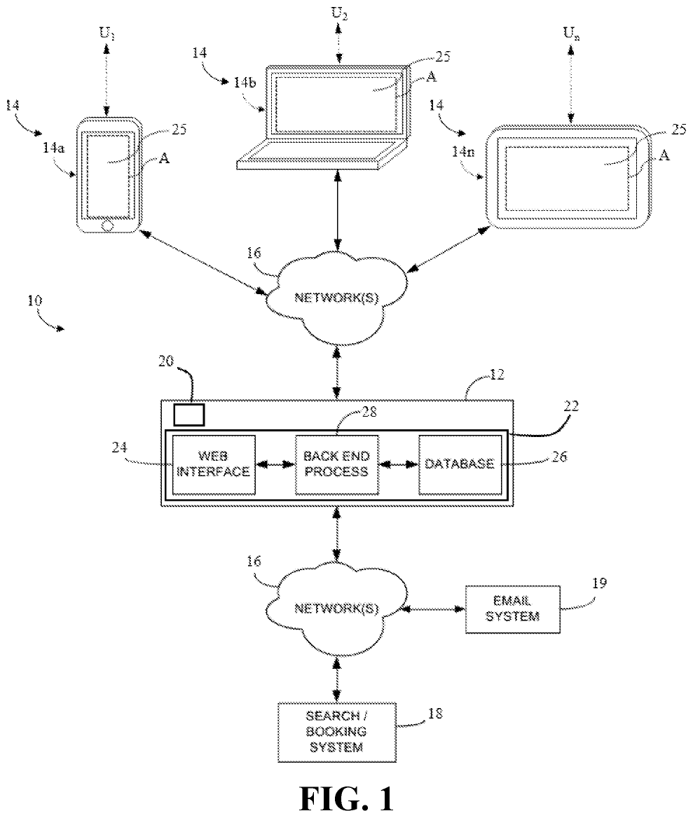

FIG. 1 illustrates an example embodiment of a system 10 for optimizing travel arrangements for groups of people in constraint-limited scenarios. In the illustrated embodiment, the system 10 includes a central server 12 and one or more user terminals 14 operated by one or more users U₁, U₂ . . . Uₙ traveling to an event. In use, the central server 12 can wirelessly communicate with each of the user terminals 14 via a network 16 to coordinate and optimize all travel arrangements for the event, as described in more detail below.

Each of the plurality of user terminals 14 can be, for example, a cellular phone, a tablet, a personal computer, or another electronic device. Here, the plurality of user terminals 14 includes a first user terminal 14a, a second user terminal 14b, and an nth user terminal 14n. Each user terminal 14 can be controlled by a distinct user U₁, U₂ . . . Uₙ (e.g., a first user U₁ controls the first user terminal 14a, a second user U₂ controls the second user terminal 14b, and an nth user Uₙ controls the nth user terminal 14n). As used herein, each of the users U₁, U₂ . . . Uₙ can also be referred to generally as a user U. As used herein, a user U is also referred to as a “team leader” or “team member.”

Each user U can be an individual person or relatively small group of persons (a potential traveler/team member and his or her assistant) tasked with making travel arrangements. In an embodiment discussed below, a plurality of users U₁, U₂ . . . Uₙ are part of a team that must travel for a common event. In this scenario, one of the plurality of users U₁, U₂ . . . Uₙ can be a team leader (e.g., the first user U₁) and the rest of the users (e.g., users U₂ to Uₙ) can be team members. In other embodiments, a plurality of users U₁, U₂ . . . Uₙ can be individuals traveling for a common goal. For example, a plurality of users U₁, U₂ . . . Uₙ can be employees of the same company traveling to a company event. The plurality of users U₁, U₂ . . . Uₙ can also include other individuals having a relationship with the team/company, such as individuals working for clients, vendors and/or other companies traveling to the same location as one or more members of a team/company utilizing the system 10.

As shown, the system 10 can include or access a travel search and booking system 18 and/or an email system 19. In an embodiment, the travel search and booking system 18 and/or the email system 19 can be operated by a third party and accessed by the central server 12 in accordance with the methods discussed herein. In an embodiment, the travel search and booking system 18 can include the Amadeus application protocol interfaces (API) and the email system 19 can include the Outlook email program. As shown, the travel search and booking system 18 and/or the email system 19 can be made accessible to the central server 12 (and, as necessary, the terminals 14) via the network 16.

The travel search and booking system 18 can include flight information from various airline services and/or operate to reserve one or more flight from various airline services. The flight information can include, for example, flight times, flight costs, seat availability, upgrade availability, and/or any other flight information related to a person's flight experience. The travel search and booking system 18 can also include hotel information from various hotels and/or operate to reserve one or more room from various hotels. The hotel information can include, for example, room availability, room costs, amenities, and/or any other hotel information related to a person's hotel experience. Several other examples of flight information and/or hotel information are provided below. In an embodiment, the travel search and booking system 18 can include multiple search and booking systems related to different airlines and/or hotels, wherein the travel search and booking system 18 can obtain information and/or reserves services from any of the multiple search and booking systems.

The user terminals 14 can communicate with the central server 12 via various communication protocols, for example, via an Internet Protocol Suite or TCP/IP supporting HTTP. Likewise, the central server 12 can communicate with the travel search and booking system 18 and/or the email system 19 via various communication protocols, for example, via an Internet Protocol Suite or TCP/IP supporting HTTP. The network 16 can comprise a public network (e.g., the Internet, World Wide Web, etc.), a private network (e.g., local area network (LAN), etc.), and/or combinations thereof (e.g., a virtual private network, LAN connected to the Internet, etc.). The network 16 can include a wired network, a wireless network, and/or a combination of the two.

The central server 12 can comprise one or more server computers, database servers and/or other types of computing devices, particularly in connection with, for example, the implementation of websites and/or enterprise software. The central server 12 can further comprise a central processor 20 and a central memory 22. The central processor 20 is configured to execute instructions programmed into and/or stored by the central memory 22. As described in more detail below, the steps of the methods described herein can be stored as instructions in the central memory 22 and executed by the central processor 20.

In the illustrated embodiment, the central memory 22 can include a web interface 24, a database 26, and back end processing instructions 28. The web interface 24, the database 26, and the back end processing instructions 28 can be controlled or accessed by the central processor 20 implementing appropriate software programs by executing the back end processing instructions 28 or other instructions programmed into and/or stored by the central memory 22.

The web interface 24 can provide a graphical user interface (“GUI”) 25 that can be displayed on a terminal 14 for a user U and used to prompt for travel-related information, and can manage the transfer of data received from and sent to the GUI 25 on the terminal 14. For example, the GUI 25 can be employed by a user U to enter data regarding travel preferences, as described in more detail below. In an embodiment, each user terminal 14 can include an application A comprising software downloaded to and executed by the terminal 14 to provide the GUI 25 and to manage communications with the web interface 24 of the central server 12. The application A can be downloaded to the user terminal 14 from the central server 12 or from some other source such as an application distribution platform.

The database 26 can store data relevant to each user's credentials, each user's travel-related information and preferences, available flight and/or hotel information, etc. In an embodiment, the database 26 can comprise a database management system (DBMS) operating on one or more suitable database server computers. Alternatively, the database 26 can comprise storage components from other systems, such as an existing relationship management tool having relevant data related to a plurality of users U, teams of users U, companies including users U, and/or users U from clients and/or other relationships already stored therein.

The back end processing instructions 28 can be operatively coupled to both the web interface 24 and the database 26, and can be programmed into and/or stored by the central memory 22 and executed by the central processor 20. In an embodiment, back end processing instructions 28 can be executed by the central processor 20 to direct operations of the central server 12 as described below in further detail. For example, the central processor 20, executing the back end processing instructions 28, can manage the receipt, storage, maintenance, etc. of relevant data (e.g., received from one or more user U via a terminal 14) concerning establishment of a team of travelers and each team member's selected travel plans, and can further coordinate communications with such team members. Additionally, the central processor 20, executing the back end processing instructions 28, can calculate optimal travel arrangements and assist in the booking of such arrangements, as described in further detail below.

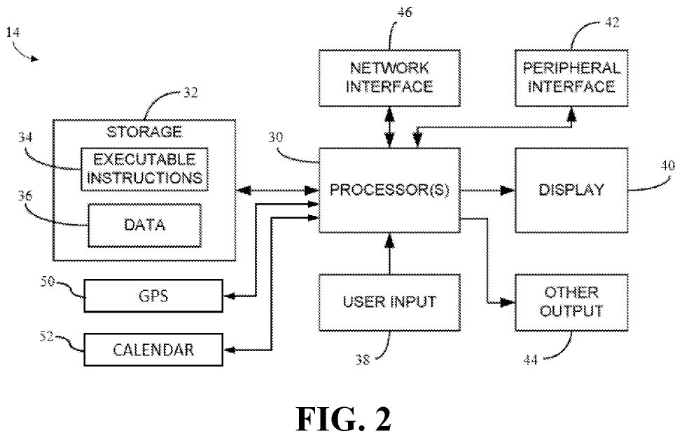

FIG. 2 illustrates a representative diagram of an example embodiment of a user terminal 14. As illustrated, a user terminal 14 can include a terminal processor 30 and a terminal memory 32. The terminal processor 30 is configured to execute instructions programmed into and/or stored by the terminal memory 32. The instructions can be received from and/or periodically updated by the web interface 24 of the central server 12 in accordance with the methods discussed below. As described in more detail below, many of the functions described herein can be stored as instructions in the terminal memory 32 and executed by the terminal processor 30.

In an embodiment, the terminal processor 30 can comprise one or more of a microprocessor, a microcontroller, a digital signal processor, a co-processor or the like or combinations thereof capable of executing stored instructions 34 and operating upon stored user data 36, wherein the instructions 34 and/or stored user data 36 are stored by the terminal memory 32. Likewise, the terminal memory 32 can comprise one or more devices such as volatile or nonvolatile memory, for example, random access memory (RAM) or read only memory (ROM). Further still, the terminal memory 32 can be embodied in a variety of forms, such as a hard drive, optical disc drive, floppy disc drive, etc. In an embodiment, many of the processing techniques described herein are implemented as a combination of executable instructions 34 and data 36 stored within the terminal memory 32.

As illustrated, each of the plurality of user terminals 14 includes one or more user input device 38, a display 40, a peripheral interface 42, one or more other output device 44, and a network interface 46 in communication with the terminal processor 30. The user input device 38 can include any mechanism for providing a user input to the terminal processor 30, for example, a keyboard, a mouse, a touch screen, a microphone and/or suitable voice recognition application, or another input mechanism. The display 40 can include any conventional display mechanism such as a cathode ray tube (CRT), a flat panel display, a touch screen, or another display mechanism. Thus, as can be understood, the user input device 38 and/or the display 40 and/or any other suitable element can be considered a GUI 25. The peripheral interface 42 can include the hardware, firmware, and/or other software necessary for communication with various peripheral devices, such as media drives (e.g., magnetic disk or optical disk drives), other processing devices, or another input source used as described herein. Likewise, the other output device 44 can optionally include similar media drive mechanisms, other processing devices or other output destinations capable of providing information to a user U of the user terminal 14, such as speakers, LEDs, tactile outputs, etc. The network interface 46 can comprise hardware, firmware and/or software that allows the terminal processor 30 to communicate with other devices via wired or wireless networks 16, whether local or wide area, private or public. For example, such networks 16 can include the World Wide Web or Internet, or private enterprise networks, or the like.

In various embodiments discussed herein, the user terminal 14 can include one or more user data device configured to track and/or periodically gather user data 36 regarding the user U of the user terminal 14. Such a user data device can include, for example, a global positioning system (“GPS”) device 50, a digital calendar 52, and/or another terminal-specific device which tracks movements and/or data usage by the user U of the user terminal 14. In an embodiment, the GPS device 50 and/or the digital calendar 52 can be integrally included with the user terminal 14. Alternatively, the user terminal 14 can be placed in wireless communication with the GPS device 50 and/or the digital calendar 52 so as to enable operation as described herein. In an embodiment, the user data gathered from a user data device such as a GPS device 50, a digital calendar 52, and/or another terminal-specific device can be stored as data 36 within the terminal memory 32 and accessed by the central server 12 as needed.

The GPS device 50 can be used, for example, to record past or present data regarding the physical location of the user terminal 14, which can be used to determine the physical location of the user U who typically uses the user terminal 14. In an embodiment, the user U of a user terminal 14 can be required to enable access to the GPS device 50 for the system 10 to determine and/or utilize the user U's past or present locations. In an embodiment, relevant data from the GPS device 50 can be stored as data 36 within the terminal memory 32 and accessed by the central server 12 as needed.

The digital calendar 52 can be, for example, a calendar application which is downloaded to the user terminal 14 and/or stores the user U's past, present, and/or future commitments. In an embodiment, the digital calendar 52 can be associated with the user U's email. The digital calendar 52 can be stored on the terminal memory 32, or can be stored on an alternative memory device and accessed by the user terminal 14 via wireless communication over the network 16. In an embodiment, relevant data from the digital calendar 52 can be stored as data 36 within the terminal memory 32 and accessed by the central server 12 as needed.

While the user terminal 14 has been described as one form for implementing the techniques described herein, those having ordinary skill in the art will appreciate from this disclosure that other functionally equivalent techniques can be employed. For example, some or all of the functionality implemented via executable instructions can also be implemented using firmware and/or hardware devices such as application specific integrated circuits (ASICs), programmable logic arrays, state machines, etc. Further, other implementations of the user terminal 14 can include a greater or lesser numbers of components than those illustrated. Further still, although a single user terminal 14 is illustrated in FIG. 2, it should be understood from this disclosure that a combination of such devices can be configured to operate in conjunction (for example, using known networking techniques) to implement the methods described herein.

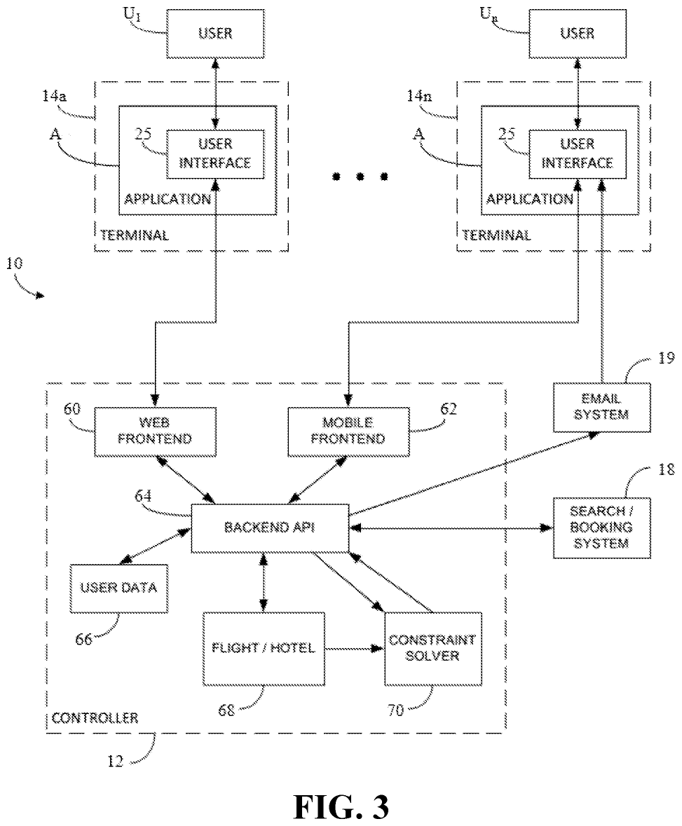

In an embodiment, the system 10 illustrated in FIGS. 1 and 2 functions as a tool to allow a plurality of users U₁, U₂ . . . Uₙ (e.g., team members) to optimize travel arrangements to a common location. A more detailed implementation of system 10 is further illustrated in FIG. 3, which is a functional block diagram of structure for implementing the system 10 in accordance with the instant disclosure.

Referring to FIG. 3, a plurality of terminals 14 (here, 14a . . . 14n) as described above are illustrated (only two shown for case of illustration). Each of the terminals 14a, 14n implements an application A, which in turn implements a graphical user interface 25 on the display 40, thereby allowing a plurality of users U to interact with the central server 12. In an embodiment, the users U can include travelers that book travel arrangements via the system 10. In an embodiment, each user U can be an administrative user (here, the user U₁) and/or a traveling user (here, the user Uₙ). In an embodiment, the administrative user U₁ invites other traveling users Uₙ to enroll in and/or use the system 10 and establishes one or more travel policies that serve as constraints on group travel arrangements. In a typical case, both the administrative user U₁ and the traveling users Uₙ can be employees of the same company, though this not a requirement.

As shown, the central server 12 can implement several operational components. For example, the web interface 24 can be used to implement various frontend 60, 62 functions (here, a web frontend 60 and a mobile frontend 62). In an embodiment, the web frontend 60 supports implementation of a website that permits the administrative user U₁ to access the system 10 and to supply necessary data concerning individual traveling users Uₙ, team or company travel policies, a client's expensing rules, etc. The mobile frontend 62 can also implement user interfaces (e.g., GUI 25) that present data concerning suggested travel arrangements based on the requirements of a plurality of users U (e.g., a group of team members) and receive individual user selections based thereon. Although FIG. 3 illustrates the administrative user U₁ accessing only the system 10 via the web frontend 60, it should be understood from this disclosure that this is not a requirement; a traveling user Uₙ can serve a dual role as an administrative user U₁ as well.

The database 28 can implement, for example, a user database 66 and a flight/hotel database 68. In an embodiment, the user database 66 includes all administrative data (e.g., user registration and credential information) and travel data (e.g., specific users' travel schedules, flight arrangements, hotel arrangements, etc.), whereas the flight/hotel database 68 stores data concerning available travel-related services (e.g., availability/rates for available flights/hotels/rental cars/etc.) in a cache that improves local availability of such information, thereby minimizing API calls. In an embodiment, the flight/hotel database 68 can periodically store information retrieved by the central server 12 from the travel search and booking system 18 to be used in accordance with the methods discussed herein.

In an embodiment, the central processor 20 can execute the back end processing instructions 28 to implement the backend API 64. The backend API 64 implements the management logic necessary for the web frontend 60 and the mobile frontend 62. To this end, the backend API 64 provides travel data (flights/hotels/etc.), travel schedules and relevant user data to the web frontend 60 and mobile frontend 62 (e.g., via a representational state transfer API (“REST API”)). The backend API 64 can also interface with the email system 19 to implement communications with individual traveling users Uₙ and with the travel search and booking system 18 as required to obtain information about available travel services and/or to book such services based on user U input/selections. Such information about available travel services may be periodically obtained and cached in the flight/hotel database 68.

As illustrated, the central server 12 further includes a constraint solver 70. In an embodiment, the central processor 20 can execute the back end processing instructions 28 to implement the constraint solver 70. The constraint solver 70 implements algorithms suitable for finding optimal solutions to constraint satisfaction problems. In an embodiment, the constraint solver 70 can be implemented as a server using the OptaPlanner constraint satisfaction solver. Here, the constraint solver 70 solves so-called planning problems in which stated goals are optimized through the use of limited resources that are subject to any number of constraints. As used herein, “optimized” solutions refer to solutions having the highest scoring results of potentially several feasible solutions, and not a “best” solution out of all possible solutions. In turn, as used herein, feasible solutions to a planning problem are solutions that do not violate any hard (i.e., not to be broken) constraints. Thus, it is to be understood that “optimal” solutions in the context of the instant disclosure are solutions that do the best job of meeting the goals and satisfying the constraints as determined within a reasonable amount of time.

In an embodiment, group travel arrangements are determined by one or more optimal and/or feasible solutions to a constraint satisfaction problem where the main goals of the trip, the date, time, and location of the meeting, are set as hard constraints that cannot be broken. It should be understood from this disclosure that other hard constraints instead of (or in addition to) these hard constraints can be established as the case, for example, of a maximum cost or budget. All other variables can be treated as soft constraints, the satisfaction of which is based on a weighted assessment of the variables in the system, as described in the example below. Each variable has a set of values. For example, one soft constraint variable, which is nevertheless typically important, is the choice of airline for any given user U. In this case, this variable has over 1000 different possible values such as “American Airlines,” “Southwest Airlines,” “Sri Lankan Airlines,” “British Airways,” etc. At the other extreme, some variables may be binary such as the variable “hotel gym,” which would either have a value of “available” or “not available.” Table 1 sets forth a non-limiting listing of further examples of various soft constraint variables in this context and their potential values.

TABLE 1

| VARIABLE | VALUES |
|---|---|
| Flight Arrival | 00:00-23:59 |
| Cost of Trip | $0-$100000 |
| Ticket Class | Basic Economy, Economy, Premium |
| | Economy, Business, First |
| Travel Time | 0+ hours |
| Stops vs Direct | Direct flight, One-stop, Two-stops, |
| | Three-stops |
| Airline | Over 5000 |
| Hotel | Over 100,000 |
| Advance Booking | Up to 30 days in advance |
| Rewards | Airline + Hotel Rewards |
| Seat type | Aisle, Middle, Window |
| Wifi | Yes or No |
| Food | Meal or no meal/Yes or no |
| Dietary | Vegetarian, Vegan, Kosher, Halal, |
| | Gluten-free |
| Outlets | Yes or No |
| Room Class | Single, Double, Triple, Quad, Queen, |
| | King, Twin, (Queen) Suite, Executive |
| | Suite, Presidential Suite, Apartments |
| Wifi | Yes or No |
| Breakfast | Yes or No |
| Gym | Yes or No |
| Smoking/Non-smoking | Yes or No |

In an embodiment, each of the variables is assigned a score ranging from 0 to a maximum value (e.g., 4), where a score of the maximum value (e.g., 4) establishes variables as hard constraints, and scores from 0 to less than the maximum value (e.g., 4) establish variables as soft constraints of increasing importance. Further still, all constituent parties related to the group travel can be (i) assigned weighs to be applied to all constraints, and (ii) permitted to assign weights reflecting relative preferences for the various soft constraints. As with the variable scores, the weights used for this purpose can range from 0 to a maximum value (e.g., 4), with 0 indicating that the variable is of no importance to that constituent and the maximum value (e.g., 4) indicating that the variable is of utmost importance (but still a soft constraint) to that constituent. Various examples of this are illustrated below with reference to Tables 2 and 3.

TABLE 2
Hard Constraint Examples

| Example | | Date of | | Time of | | Location | |
|---|---|---|---|---|---|---|---|
| Variables | | Event | | Event | | of Event | |
| | Weight | Score | Weighted | Score | Weighted | Score | Weighted |
| Client | 4 | 4 | 16 | 4 | 16 | 4 | 16 |
| Com- | 3 | 4 | 12 | 4 | 12 | 4 | 12 |
| pany | | | | | | | |
| Team | 2 | 4 | 8 | 4 | 8 | 4 | 8 |
| Indi- | 1 | 4 | 4 | 4 | 4 | 4 | 4 |
| vidual | | | | | | | |

| | | | |
|---|---|---|---|
| Average | 10 | 10 | 10 |

TABLE 3
Soft Constraint Examples

| Example | | Ticket | | Flight Travel | | Stops vs. | |
|---|---|---|---|---|---|---|---|
| Variables | | Class | | Time | | Direct | |
| | Weight | Score | Weighted | Score | Weighted | Score | Weighted |
| Client | 4 | 3 | 12 | 0 | 0 | 0 | 0 |
| Com- | 3 | 3 | 9 | 0 | 0 | 0 | 0 |
| pany | | | | | | | |
| Team | 2 | 0 | 0 | 1.5 | 3 | 0 | 0 |
| Indi- | 1 | 2.5 | 2.5 | 3.5 | 3.5 | 3.5 | 3.5 |
| vidual | | | | | | | |

| | | | |
|---|---|---|---|
| Average | 5.875 | 1.625 | 0.875 |

Tables 2 and 3 list the various constituents applicable to a typical group travel scenario as may be the case of an enterprise arranging group travel for the benefit of clients. As shown, these constituents include the Client, the Company, the Team, and the Individual travelers. As shown in this example, the Client is assigned the highest weight, followed in order by the Company, the Team and the Individuals (e.g., as shown by the first “Weight” column in Tables 2 and 3). This has the effect that the Client's preferences, if any, for soft constraints will be weighted more heavily than those of the Company, Team or any Individual; likewise, the Company's preferences will be weighted more heavily than those of the Team or any Individual, and the Team's preferences will be weighted more heavily than those of any Individual. In the example of Table 2, all of the illustrated variables (e.g., Date of Event, Time of Event, and Location of Event) have scores of 4 assigned by default, again, indicating that these are hard constraints. Consequently, all of the variables in Table 2 have average weighted values of 10 (equal, essentially, to the total of the constituent weights). On the other hand, Table 3 shows examples of three soft constraint variables (e.g., Ticket Class, Flight Travel Time, and Stops vs. Direct). In this case, each constituent is permitted to assign a score indicating their relative preference for this constraint. For example, in Table 3, both the Client and the Company have assigned scores of 0 to the Flight Travel Time, indicating that these constituents have no preference for the lengths of flights. On the other hand, the Team (as determined, for example, by the team leader) has assigned a score of 1.5 and the listed Individual (representative of the many that would be on the team) has assigned a score of 3.5, indicating that flight times are of relatively minimal importance to the Team but of more particular importance to the Individual. As shown, the assigned scores are multiplied by each constituent's weight, and the resulting weighted scores are averaged to provide, essentially, an overall importance of that soft constraint variable to the overall constraint satisfaction problem. Note that each of the soft variables has an average weighted score that is less than that for each of the hard constraint variables. Thus, in an example embodiment, the average weighted score (AWS) for a variable can be calculated as follows:

$$AWS = \frac{( W 1 \times S 1 ) + ( W 2 \times S 2 ) + … ( Wn \times Sn )}{n} . \qquad ( Equation 1 )$$

In the above equation, W₁, W₂ and Wₙ refer to party weights for a Client, Company, Team or Individual, S₁, S₂ and Sₙ refer to corresponding scores attributed by or for the Client, Company, Team or Individual, and n refers to the number of clients, companies, teams or individuals included in the calculation.

By repeating this calculation over all available variables, a ranking of relative importance of each variable can be provided. An example of this ranking is illustrated in Table 4. As shown in Table 4, each of the hard constraints have the maximum possible average weighted score (here, 10), and each of the soft constraints thereafter have average weighted scores less than the maximum in decreasing order of importance. Thus, in this example, the overall importance of the Cost of Trip soft constraint is almost ten times greater than the overall importance of the Food and Preferred Airport soft constraints (7.375 versus 0.75).

TABLE 4
Example Average Weighted Scores

| | AVERAGE WEIGHTED |
|---|---|
| VARIABLE | SCORE (AWS) |
| Date of Event | 10 |
| Time of Event | 10 |
| Location of event | 10 |
| Cost of Trip | 7.375 |
| Ticket Class | 5.875 |
| Hotel | 5.875 |
| Airline | 5.75 |
| Room Class | 5.25 |
| Ground Time | 5.25 |
| Advance Booking | 4.375 |
| Flight Arrival | 2.5 |
| Hotel Wifi | 2.375 |
| On-Board Wifi | 1.875 |
| Outlets | 1.875 |
| Flight Travel Time | 1.625 |
| Breakfast | 1.5 |
| Stops vs Direct | 0.875 |
| Carry-on included | 0.875 |
| Rewards | 0.875 |
| Seat Type | 0.875 |
| Dietary | 0.875 |
| Food | 0.75 |
| Preferred Airport | 0.75 |

Having thus established the relative significance of the constraints, the optimal travel arrangements (flights, hotels, etc.) will correspond to those arrangements that satisfy all of the hard constraints and maximize overall satisfaction of the soft constraints.

Thus, using for example the above-determined weights, the central processor 20 can implement the constraint solver 70 to assign an overall score (S) to a plurality of travel options available for the user which meet the hard constraints. The overall score (S) for one of the plurality of travel options can be calculated, for example, as follows:

$$S = {AWS}_{1} \times {C}_{1} = {AWS}_{2} \times C 2 + {AWS}_{n} \times {C}_{n} . \qquad ( Equation 2 )$$

In the above equation, AWS₁, AWS₂ and AWSₙ are average weighted scores for n number of variables, and C₁, C₂ and Cₙ are values for n number of constraints related to whether a respect travel option meets that constraint. In an embodiment, C₁, C₂ and Cₙ can be either 0 or 1, wherein C is 0 if the constraint is not met, and C is 1 if the constraint is met. Other numeric values can also be used. Those of ordinary skill in the art will further recognize from this disclosure that scores can be calculated using other derivative and/or alternative equations or values.

With scores for a plurality of travel options, the constraint solver 70 can rank one or more of the plurality of travel options for presentation to the user U. In an embodiment, the constraint solver can further perform another analysis which confirms that all of the hard constraints have been satisfied for any travel option presented to the user U. The central server 12 can then cause the GUI 25 of the user U's user terminal 14 to display one or more optimal and/or feasible travel option to the user U, so that the user U can select a travel option for booking. In an embodiment, the GUI 25 can present the travel options as a ranking according to the calculated score, so that the user U views a most preferred travel option first. The GUI 25 can further present the calculated scores to the user U. In another embodiment, the GUI 25 can eliminate any travel option which has a score that does not meet a minimum threshold. In an embodiment, the GUI 25 can separate optimal and feasible travel options for presentation to the user U. The GUI 25 can also first present optimal travel options as being preferred, and then present feasible travel options if the user U rejects one or more optimal travel option.

In an embodiment, the central server 12 can use third party data related to one or more aspects of the travel options when ranking the travel options for presentation to the user U. For example, the central server 12 can access third party websites (e.g., Better Business Bureau, Yelp, etc.) and access various ratings (e.g., consumer ratings) to use when ranking the travel options for presentation to the user U. In an embodiment, the central server 12 can alter the previously calculated scores(S) for each of the plurality of travel options based on the third party ratings. For example, the central server 12 can multiply each calculated travel score (S) by a third party rating to obtain an adjusted score, wherein the travel options can then be ranked by the adjusted score (e.g., Adjusted Score=S×Third Party Rating). In another embodiment, the central server 12 can eliminate travel options which do not meet a minimum threshold rating on a third party website. In yet another embodiment, the central server 12 can take the travel options having the highest calculated scores, and reorder those travel options for presentation to the user U based on the third party ratings. In each of these ways, the central server 12 can use up-to-date ratings provided by other third parties when making a recommendation to a user U, and can rank the plurality of travel options accordingly for presentation to the user U.

Referring once again to FIG. 3, the administrative user U₁, working through the GUI 25 provided by the web frontend 60 and application user interface A, can invite traveling users Uₙ to register with the system 10 using conventional registration techniques (i.e., setting up usernames and passwords, preferred flyer programs, etc.). As part of the registration procedure, implemented through the mobile frontend 62, each user U can provide various individual preferences. Additionally, in this same manner, the administrative users U₁ can provide information detailing any travel policies, for example, an enterprise's employee travel policy. In an embodiment, such a policy can include a number of constraints such as, but not limited to, permitted flight accommodations (e.g., no first class tickets for employees less than certain seniority levels, coach class for trips less than four hours, business class for trips over four hours, senior executives are permitted to fly business class on international flights, purchase of extra legroom is permitted for flights over six hours, hotel budget not to exceed $X/night, etc.) In some instances, a given institution can have multiple such travel policies where, for example, one policy pertains to domestic travel and another policy pertains to international travel. Regardless, such policies hold variables that are sources of constraints for constraint satisfaction problems as described herein. As shown, the data obtained by the web frontend 60 can be provided to the backend API 64 for storage in the user database 66.

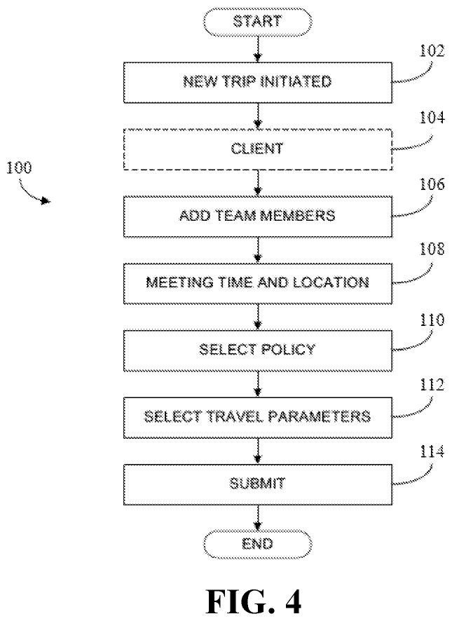

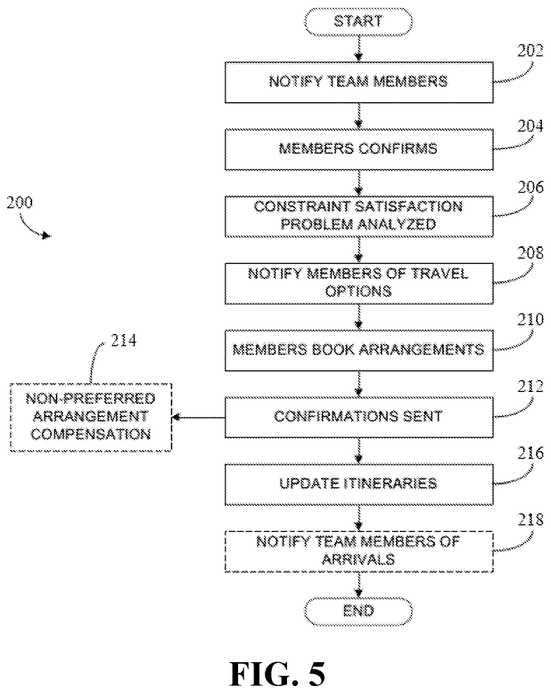

Using the mobile frontend 62, the traveling users Uₙ (which can include the administrative user U₁) can provide the parameters for establishing a particular team of travelers and the parameters for their proposed travel needs, as described in greater detail below relative to FIGS. 4 and 5. Based on the identified team members, travel information as provided by the flight/hotel database 68 and any identified constraints, the backend API 64 implements the constraint solver 70 to find an optimal solution to the resulting constraint satisfaction problem. In turn, the constraint solver 70 returns one or more optimized and/or feasible solutions in the form of, for example, suggested travel options (e.g., flight and/or hotel options) for each of the team members. Based on these proposed travel options, the backend API 64 can send an email to each traveling user Uₙ (e.g., team member) asking them to review the suggested travel options. Each traveling user Uₙ can then access the system 10 via the mobile frontend 62 to review and select from the suggested travel options. Here, the GUI 25 on the user U's user terminal 14 can present the travel options as a ranking according to the calculated overall score, so that the user U views a highest-scoring travel option first. In an embodiment, the suggested travel options identified as the optimal solutions can nonetheless violate a given traveling user Uₙ's soft constraint, e.g., a constraint that should not be broken if possible, and the traveling user Uₙ's selection of such an option can invoke a compensation scheme as described below. Based on these selections, the backend API 64 can interact with the travel search and booking system 18 to finalize and book the selected travel option.

FIG. 4 illustrates an example embodiment of a method 100 for setting up optimized travel arrangements for a plurality of users U₁, U₂ . . . Uₙ. Some or all of the steps of method 100 can be stored as instructions on the central memory 22 and/or terminal memory 32 and can be executed by the central processor 20 and/or terminal processor 30 in accordance with the respective instructions stored on the central memory 22 and/or terminal memory 32. It should be understood that some of the steps described herein can be reordered or omitted without departing from the spirit or scope of method 100. In an embodiment, the processing illustrated in FIG. 4 concerns the initiation of a group of travelers and entry of parameters concerning a group trip.

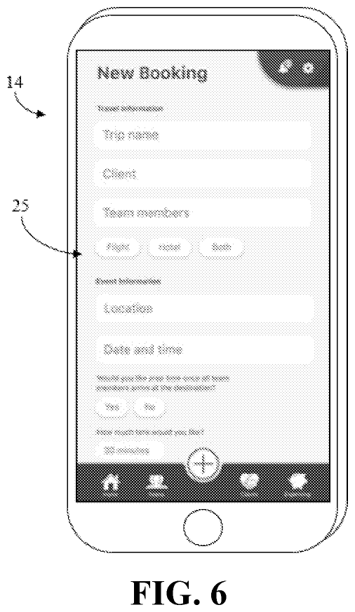

At step 102, a first user U₁ (e.g., a team leader, who can also be part of a team of traveling users U) initiates the formation of a team of users U for a new trip. Here, for example, the first user U₁ can access the central server 12 via the network 16 using a first user terminal 14a. The first user U₁ can thereafter input at least one first user input including information regarding various aspects of the team using the GUI 25 of the first user terminal 14a. The information can include, for example, (i) a trip name, (ii) a client name, (iii) the team members (e.g., the plurality of traveling users U₁, U₂ . . . Uₙ making the trip), (iv) whether one or both of a flight and/or hotel is needed for each team member), (v) the location of the event requiring the travel, (vi) the date and/or time of the event requiring the travel, (vii) preparation time needed at the location prior to the event, and/or (viii) other information regarding the trip. An example embodiment of a GUI 25 which can be provided to the first user U₁ using the first user terminal 14a at step 102 is illustrated at FIG. 6.

At step 104, the first user U₁ can optionally select a particular client related to the trip. In an embodiment, costs and/or expenses related to a trip can be billable to a client. Such clients often have travel policies imposed on their vendors, and such travel policies can be included in those provided by the administrative user as described above in connection with FIG. 3. Thus, by selecting a client at step 104, the client preferences related to hard and soft restraints (e.g. assigned scores) can be accessed by the system 10 and incorporated into the calculations that follow. In an embodiment, the client preferences related to hard and soft restraints can be stored by the central memory 22 and retrieved upon selection by the first user U₁ at step 104.

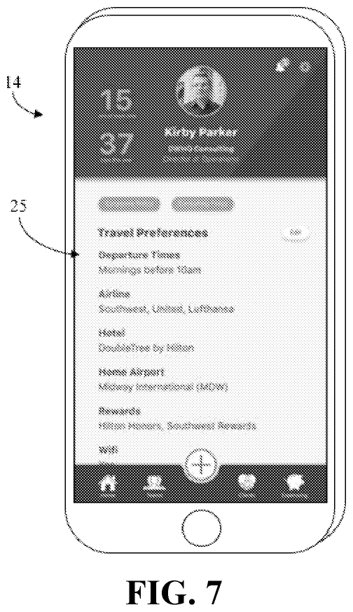

At step 106, the first user U₁ can specify specific team members (for example, through entry of such users' names or selection from a directory of users) that should be included in this trip. For example, in this embodiment, the first user U₁ can select a second user U₂, a third user U₃, and an nth user Uₙ. In making the selection, the first user U₁ can also view profiles for each of the potential team members, wherein the profiles can contain preloaded preferences inputted into another user terminal 14 by the corresponding user U. An example embodiment of a GUI 25 showing a user profile with several preferences is illustrated at FIG. 7.

At step 108, the first user U₁ can enter the location and desired data/time for the trip into the GUI 25 of the first user terminal 14a (e.g., “Orlando, Florida, arriving Sep. 5, 2019”). The first user U₁ can also enter information relevant to return travel arrangements, e.g., “departing Sep. 8, 2019,” and/or whether any time for other team members to meet as a group is desired upon landing. For example, the first user U₁ can require that the team land or arrive at a hotel at a particular time before the event that the team is traveling to.

At step 110, any applicable policies relating to hard or soft restraints can be identified. In an embodiment, the first user U₁ can identify specific policies relating to hard or soft constraints for the trip. Additionally, the system 10 can automatically determine applicable policies relating to hard or soft constraints for the trip. The applicable policies can relate to the client selected at step 104, to one or more user U selected at step 106, to the company that that employs one or more user U selected at step 106, and/or to other factors as described herein. In an embodiment, where identification of team members at block 106 also serves to identify each team member's seniority within the enterprise, separate policies for executive and non-executive team members can be applied accordingly. Similarly, based on the indicated destination and the known preferred points of departure for each team member, policies regarding domestic versus international travel can be applied as necessary.

At step 112, the first user U₁ can select other travel parameters, such as whether the system 10 should establish flight arrangements only, hotel arrangements only, or both flight arrangements and hotel arrangements. Other travel arrangements (e.g., rental car) can also be included as needed. Regardless, at step 114, having thus established the requirements for the trip, the first user U₁ can submit the provided data to the backend API 64 for further processing as described herein.

FIG. 5 illustrates an example embodiment of a method 200 for optimizing travel arrangements for a plurality of users U₁, U₂ . . . Uₙ following submission of a group trip as described above relative to FIG. 4. Some or all of the steps of method 200 can be stored as instructions on the central memory 22 and/or terminal memory 32 and can be executed by the central processor 20 and/or terminal processor 30 in accordance with the respective instructions stored on the central memory 22 and/or terminal memory 32. It should be understood that some of the steps described herein can be reordered or omitted without departing from the spirit or scope of method 200. As used in the description of FIG. 5 below, a “team member” can refer, for example, to a second user U₂ who is part of the team set up by the first user U₁ using the method 100 of FIG. 4 above. The “team member” can also refer to the third user U₃ . . . nth user Uₙ for as many users U as are included on the team.

At step 202, the system 10 via the backend API 64 notifies each team member (e.g., the second user U₂, the third user U₃, and the nth user Uₙ) of the submitted group trip, e.g., via the email system 19. Here, each of the team members can receive a separate notification on a separate user terminal 14 (e.g., the second user U₂ receives a notification on a second user terminal 14b, the third user U₃ receives a notification on a third user terminal 14c, and the nth user Uₙ receives a notification on an nth user terminal 14n). The notification can request that each team member log into a respective user terminal 14 and access the system 10 within a predetermined amount of time.

At step 204, each team member uses his or her own user terminal 14 to confirm particulars of the trip such as planned departure city/airport and return date. Here, each team member can also enter user inputs (e.g., second user inputs) including preferences relating to any of the hard or soft constraints discussed above. Alternatively, each team member can already have preloaded user inputs (e.g., second user inputs) including preferences relating to any of the hard or soft constraints discussed above which the system 10 can have stored in database 26. In either case, the user inputs (e.g., second user inputs) can be accepted (either automatically or with affirmative confirmation from the respective user via the user terminal 14) and sent to the central server 12 for further processing.

In an embodiment, the system 10 can access the digital calendar 52 of each team member, for example, via each team member's respective user terminal 14. Based on appointments already entered into the team member's digital calendar 52, the system 10 can automatically generate hard or soft constraints regarding dates and times that the team member is available to travel. For example, if the team member is required to be in a desired travel location by 5:00 pm on a weekday according to the information entered in method 100, but also has a personal meeting scheduled in a current location from 9:00 am to 10:00 am on that same day, then the system can set hard restraints using the 10:00 am and 5:00 pm times, wherein the team member's flight must leave after 10:00 am and arrive before 5:00 pm (or earlier or later to account for delays and/or time in the airport). In an embodiment, the GUI 25 can also notify the team member of the preexisting meeting determined from the digital calendar 52 (e.g., the 9:00 am to 10:00 am meeting) and ask the team member whether the meeting is mandatory. If the meeting is mandatory, then the system 10 can automatically set the meeting time as a hard constraint. If the meeting is not mandatory, then the system can automatically set the meeting time as a soft constraint which can be broken if necessary, but which is preferably not broken. In an embodiment, the team member can also assign a score based on the perceived importance of the preexisting meeting, which can be used in the calculations as described herein.

In another embodiment, the system 10 can access the team member's GPS device 50 and use data from the GPS device 50 to set constraints. For example, the system 10 can determine the current location of the user terminal 14, and thus the likely current location of the team member, and use that current location as the departure location for travel. In an embodiment, the system 10 can automatically determine airports within a certain range of the team member's current location based on data from the GPS device 50, and can proceed to search all airports within that range for flights that meet the hard and/or soft constraints as described herein. The system 10 can further access the team member's GPS device 50 and use historical data from the GPS to set constraints, thus determining where the team member is located most often in comparison to local airports.

At step 206, the user input information regarding each team member (e.g., information entered by each team member via a GUI 25 of each separate user terminal 14) is transmitted to the central server 12 via the network 16 so that the constraint solver 70 can satisfy the constraint satisfaction problem. More specifically, as described above, the constraint solver 70 can receive flight and/or hotel information from the travel search and booking system 18 and/or the flight/hotel database 68. The constraint solver 70 can then calculated an average weighted score and/or an overall score for a plurality of travel options using the hard and/or soft constraints specified by the system 10 and/or team members as described herein. In an embodiment, the average weighted score and/or overall score can be calculated according to Equations 1 and 2 above and/or other derivative or alternative equations. In an embodiment, the constraint solver 70 can narrow a plurality of travel options available on the travel search and booking system 18 to a predetermined number of travel options or to only the travel options having an overall score that meets a predetermined threshold.

At step 208, the constraint solver 70 has satisfied the constraint satisfaction problem and calculated one or more optimal or feasible solution for travel options based on the calculations. The system 10 can thereafter present each of the team members with one or more suggested travel option based on the provided optimal and/or feasible solutions. The suggested travel options can be presented, for example, via the GUI 25 of each user terminal 14. In an embodiment, the suggested travel options can be ranked on the GUI 25 according to their respective calculated optimal scores.

At step 210, each team member can use the GUI 25 on his or her respective user terminal 14 to selection a travel option for booking. In an embodiment, the team member is first presented with the travel option having the highest overall score and asked to review and accept/decline that travel option. If the team member finds a reason that the first option is unsuitable, then the team member can be presented with the travel option having the second highest overall score, and so on until the team member is presented with a suitable option for selection. Once a selection has been made, the user terminal 14 transmits the selection back to the central server 12 to initiate processing by the backend API 64 to interface with the travel search and booking system 18 to book the requested travel option.

At step 212, confirmation of the booked arrangements is sent by the backend API 64 to the user terminal 14 of the team member. In an embodiment, the system 10 can further access the team member's digital calendar 52 and cause the booked arrangements to be entered in the team member's digital calendar 52. Here, the backend API can notify one or more of the other team members of the booked arrangements via respective user terminals 14, so that the entire team has access to the booked arrangements of other team members.

At step 214, the system 10 can initiate processing to compensate individual users U for non-preferred travel arrangements (in the context of that user U's preferences) that were selected by virtue of the options presented in keeping with the optimal solutions. For example, though a user U may have indicated their preference (as a soft constraint) to avoid domestic flights leaving their home airport later than 8 pm, the constraint solver 70 can arrive at optimal solutions that require this preference not being met in order to meet all of the hard constraints for the trip. Consequently, this user U can be forced to accept travel arrangements that are contrary to his or her stated preference. Recognizing this potential consequence, a “compensation” scheme can be used to acknowledge the fact that any given user U may not be able to have his or her preferences met in order for the team to meet its goals in a way that best satisfies all constraints.

For example, in an embodiment, each type of individual preference can be assigned points according to a scoring system. For example: Seat=40 points; Airline choice=100 points; Hotel choice=100 points; Time of day=20 points; Stops vs direct preference=60 points; Flight travel time=50 points; Room type=40 points; Breakfast=20 points; Gym=20 points; Preferred airport=40 points; Outlets=10 points; Carry-on included=30 points. Thus, any time one of these preferences is not satisfied, the user U can be awarded the corresponding number of points. It should be appreciated from this disclosure that some reward metric other than points can also be used for this purpose, and further that preferences other than or in addition to those shown can be employed. Additionally, it is contemplated by this disclosure that the user U can also engage in activities that earn points, rather than points that are awarded as compensation for unmet preferences. For example, a user U can receive points for various actions according to the following scale: share information about the system 10 on social media=10 points; like a social media post about the system 10=5 points; submit a review about the system 10=15 points, etc.

Based on the points thus accumulated over time, each user U can be provided the option to redeem his or her points for goods or services. In an embodiment, such goods or services are organized in tiers according to an increasing number of required points to redeem. For example a first tier can be provided for redemption of between 500 and 1,000 points (including goods/services such as gift cards to third-party partners, e.g., Starbucks); a second tier can be provided for redemption of between 1,000-5,000 points (including goods/services such as restaurant discounts); and a third tier can be provided for redemption of between 5,000-10,000 points (including goods/services such as flight or hotel discounts). Those skilled in the art will appreciate from this disclosure that myriad redemption schemes can be devised for this purpose.

At step 216, regardless of any potential compensation provided, individual and group itineraries are updated as travel arrangements are booked using the travel search and booking system 18. This information can thereafter be shared with the group members so that all members are aware of the final arrangements as they are confirmed.

At step 218, on the day of travel, all team members can be optionally notified at of the arrival of each team member at the destination. In this manner, all team members can keep track of the group and coordinate as necessary at the destination. In an embodiment, the system 10 can further access the travel search and booking system 18 and notify all team members if one team member's flight has been delayed or canceled.

In an embodiment, the system 10 can access the GPS device 50 of each team member's respective user terminal 14, and can use the data from the GPS device 50 to notify other team members of each team member's current location. For example, knowing the time of each team member's respective flight arrangements, the system 10 can use data from a respective GPS device 50 to determine whether each team member got on the flight and/or arrived at the meeting destination. In an embodiment, the system 10 can track whether the team member arrived at the proper airport prior to the flight, whether the GPS device 50 continues to track the flight path during the flight, and/or whether the GPS device 50 was disabled around the time that the flight took off (e.g., the GPS device 50 being turned off can indicate, for example, that the team member got on the airplane and turned the user terminal 14 into flight mode, thus temporarily disabling communication for data from the GPS device 50. The system 10 can further track each GPS device 50 and notify others when each team member arrives at the meeting destination.

In an embodiment, the system 10 can continuously monitor the travel search and booking system 18 to determine whether a flight has been delayed and/or canceled. If a flight is delayed, the system 10 can again process the new flight time and/or other new information using the constraint solver 70 to determine whether the user's chosen travel option still meets the hard constraints previously determined with respect to the trip. If the flight no longer meets the hard constraints, or if other travel options now score higher than the originally booked flight, then the system 10 can either automatically book the new highest scoring flight or can present one or more new travel option to the respective team member via the GUI 25 of that team member's user terminal 14. Likewise, if a team member's flight is canceled, then the system 10 can again process available travel options using the constrain solver 70 to determine whether another available travel option still meets the hard constraints previously determined with respect to the trip. The system 10 can either automatically book the new highest scoring travel option or can present the travel option to the respective team member via the GUI 25 of that team member's user terminal 14.

By automatically booking a new flight after a cancelation or delay, the system 10 can ensure that the team member is able to reserve that travel option for the trip, knowing that the team member is required to be at the meeting location at a certain time. In an embodiment, the system 10 can first book the highest scoring travel option for the team member, and then notify the team member that the highest scoring travel option has been booked. The team member can then be notified of the change and allowed to cancel the new reservation and/or select another of the highest scoring travel options. Most airlines allow cancelations up to 24 hours after booking, so in an embodiment the system 10 can notify the team member of the new reservation and allow the team member 24 hours to review and/or change the new reservation.

In an embodiment, each of the steps of method 200 in FIG. 5 can be performed automatically by the system 10 without receiving any user affirmative user input from the team members once the team leader has initially inputted the trip details as shown for example in FIG. 4. That is, the team leader can select the team and enter trip details including at least one first user input. The system 10 can then automatically access second user input including preferences for the team members from the user terminals 14 and/or user database 66, and can automatically calculate overall scores for a plurality of travel options for each team member and thereafter automatically book the highest scoring option for each team member. In this way, the system 10 can ensure that the optimal solutions are reserved for each team member as soon as possible, thus achieving a minimum trip price and ensuring that the travel options are not reserved by other third parties before the team member has a chance to confirm. In an embodiment, each team member can then be notified of the booking and given a period of time (e.g., 24 hours) to cancel the booked travel option and make new arrangements.

FIGS. 6 to 10 illustrate various embodiments of a GUI 25 that can be displayed on a user terminal 14 during the method 100 and/or the method 200 as described above. It should be understood from this disclosure that FIGS. 6 to 10 illustrate examples only and are not intended to limit the methods discussed herein.

FIG. 6 illustrates an example embodiment of a GUI 25 during method 100 when a team leader (e.g., a first user U₁) can input at least one first user input including information regarding various aspects of the team using the GUI 25 of the first user terminal 14a. As illustrated, the first user input can include, for example, (i) a trip name, (ii) a client name, (iii) the team members (e.g., the plurality of traveling users U₁, U₂ . . . Uₙ making the trip), (iv) whether one or both of a flight and/or hotel is needed for each team member), (v) the location of the event requiring the travel, (vi) the date and/or time of the event requiring the travel, (vii) preparation time needed at the location prior to the event, and/or (viii) other information regarding the trip.

FIG. 7 illustrates an example embodiment of a GUI 25 during method 100 when a team leader (e.g., a first user U₁) views the profile of a team member (e.g., a second user U₂). As illustrated, the profile can inform the team leader of one or more preferences of that team member, which in some cases can immediately alert the team leader of an issue that the team member might encounter when making travel arrangements. Here, the profile displays the team member's preferences regarding departure time, airline, hotel, home airport, rewards, and wifi, though it should be understood this disclosure that other options can also be included, such as the other options discussed above. In an embodiment, the team member can leave certain possible preference options blank, indicating that the team member has no preference with respect to that option.

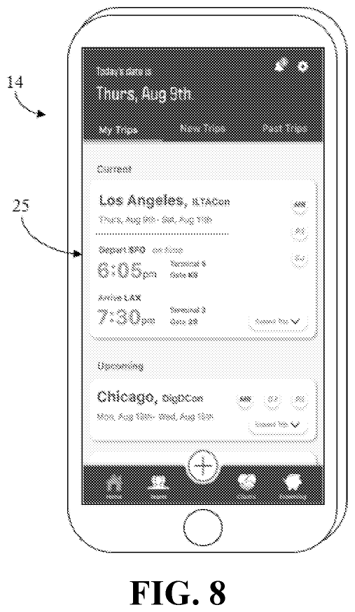

FIG. 8 illustrates an example embodiment of a GUI 25 showing a current trip for the user U, as well as an upcoming trip. In this embodiment, team members are shown according to their initials (e.g., MR, PS, CJ, etc.) along with the particulars of the relevant travel arrangements. In this way, each team member can easily access other team member's travel arrangements, for example, by selecting the initials on the GUI 25.

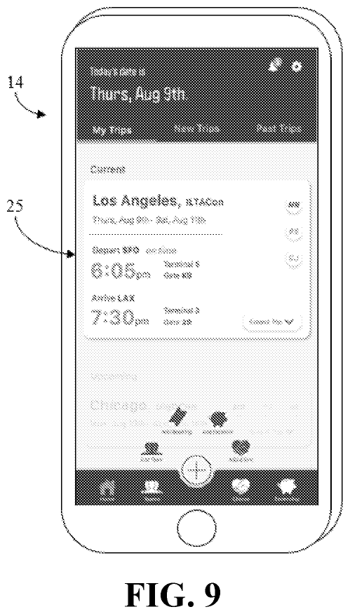

FIG. 9 illustrates an example embodiment of a more detailed view of FIG. 8 in which various “additions” can be selected through activation of the illustrated “+” button. Specifically, the user U of the user terminal 14 can use the “+” button can add team members, bookings, trip expenses or a client for this particular trip.

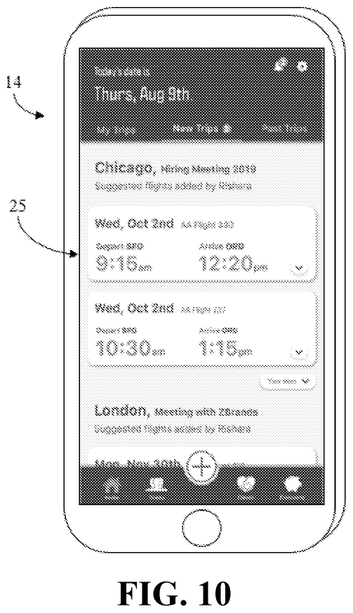

FIG. 10 illustrates an example embodiment of a GUI 25 when the user U has navigated to the “New Trips” tab shown in FIGS. 8 to 10 such that suggested trip options are presented to the user U in accordance with one or more optimal and/or feasible solution determined by the system 10. The GUI 25 shown in FIG. 10 can be, for example, the GUI 25 presented to the user U at step 208 of method 200 discussed above. Here, the user U is presented with two travel options for an upcoming trip to Los Angeles. In an embodiment, these two travel options (e.g., the 9:15 and 10:30 options) can be the two travel options with the highest overall score calculated by the constraint solver 70 during step 206 of method 200. In an embodiment, the first option (the 9:15 option) is listed first because it obtained the highest overall score, and the second option (the 10:30 option) is listed second because it obtained the second highest overall score. In an embodiment, these two options are the only options presented because they were the only travel options which had overall scores meeting a predetermined threshold during step 206 of method 200. The user U of the user terminal 14 can thereafter use the GUI 25 to select one of the two suggested travel options for booking by the system 10 at step 210 of method 200.

The embodiments described herein provide improved systems and methods for optimizing travel arrangements for groups of people in constraint-limited scenarios. By condensing the data using the various methods and calculations discussed herein, processing speeds can be increased and memory space can be conserved in comparison to other systems. Particularly for large organizations managing hundreds of employees who can be traveling regularly in various-sized teams, the systems and methods enable trips to be planned with case, at reduced costs, without wasting valuable employee time searching for travel accommodations. Thus, time, processing speeds and memory space are conserved in comparison to each team member for searching for traveling options, communicating with other team members, and booking the travel options individually. It should be understood that various changes and modifications to the systems and methods described herein will be apparent to those skilled in the art and can be made without diminishing the intended advantages.

### GENERAL INTERPRETATION OF TERMS

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to the systems and methods discussed herein.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A system for using a plurality of global positioning system (“GPS”) devices to execute travel for geographically-diverse groups of travelers traveling for a common purpose, the system comprising:
a first user terminal including a first GPS device configured to record first location data regarding a first physical location of the first user terminal, the first user terminal running a first application enabled for access to the first GPS device and a first digital calendar for a first user;
a second user terminal including a second GPS device configured to record second location data regarding a second physical location of the second user terminal, the second user terminal running a second application enabled for access to the second GPS device and a second digital calendar for a second user;
a central server configured to communicate with the first user terminal via the first application and the second user terminal via the second application, the central server including at least a processor and a memory, the processor configured to execute instructions stored on the memory to cause the central server to: (i) determine a plurality of first times that the first user is available using first appointments entered in the first digital calendar and a plurality of second times that the second user is available using second appointments entered in the second digital calendar; (ii) determine a first location of the first user terminal from the first GPS device and a second location of the second user terminal from the second GPS device; (iii) reserve a first travel option for the first user departing from a first airport within a first predefined range of the first location at a first time when the first user is available according to the first digital calendar and a second travel option for the second user departing from a second airport within a second predefined range of the second location at a second time when the second user is available according to the second digital calendar, the first travel option and the second travel option arriving in a common location on a same day; (iv) use the first GPS device to determine whether the first user terminal arrived at the first airport on the same day prior to the first time and was subsequently disabled; (v) use the second GPS device to determine whether the second user terminal arrived at the second airport on the same day prior to the second time and was subsequently disabled; (vi) when the first user terminal did not arrive at the first airport on the same day prior to first time or the first GPS device was not subsequently disabled, book a new first travel option for the first user departing from the first airport at a different first time when the first user is available according to the first digital calendar and notify the second user that the first user is traveling according to the new first travel option; and (vii) when the second user terminal did not arrive at the second airport on the same day prior to the second time or the second GPS device was not subsequently disabled, book a new second travel option for the second user departing from the second airport at a different second time when the second user is available according to the second digital calendar and notify the first user that the second user is traveling according to the new second travel option.

2. The system of claim 1, wherein
the first application is configured to accept, from the first user terminal, a first user input setting the common location and the same day for the second user.

3. The system of claim 1, wherein
the memory stores a database corresponding a plurality of constituents to a plurality of soft constraints, the plurality of constituents including at least two constituents that are assigned different weights, the plurality of soft constraints each including a value between a minimum value and a maximum value, and
the processor is configured to use the plurality of soft constraints when determining the first travel option and the second travel option.

4. The system of claim 3, wherein
the database further stores a plurality of hard constraints corresponding to the plurality of constituents, and
the processor is configured to use the plurality of soft constraints and the plurality of hard constraints when determining the first travel option and the second travel option.

5. The system of claim 1, wherein
the processor is configured to rank a plurality of first travel options and enable the first user to select the first travel option via the first application at the first terminal, and
the processor is configured to rank a plurality of second travel options and enable the second user to select the second travel option via the second application at the second user terminal.

6. The system of claim 5, wherein
the processor is configured to cause a first graphical user interface of the first application to display the plurality of first travel options such that the plurality of first travel options are arranged according to respective first scores, and
the processor is configured to cause a second graphical user interface of the second application to display the plurality of second travel options such that the plurality of second travel options are arranged according to respective second scores.

7. The system of claim 1, wherein
the central server is configured to cause the first travel option to be entered in the first digital calendar and the second travel option to be entered in the second digital calendar.

8. The system of claim 1, wherein
the central server is configured to use the first GPS device to determine whether the first user terminal arrived at the common location and thereafter notify the second user that the first user arrived at the common location, and
the central server is configured to use the second GPS device to determine whether the second user terminal arrived at the common location and thereafter notify the first user that the second user arrived at the common location.

9. The system of claim 1, wherein
the central server is configured to automatically book the new first travel option upon determining that the first user terminal did not arrive at the first airport on the same day prior to the first time or the first GPS device was not subsequently disabled.

10. The system of claim 1, wherein
the central server is configured to enable the first user to identify the second user prior to determining the second location of the second user terminal from the second GPS device.

11. A method of using a plurality of global positioning system (“GPS”) devices to execute travel for geographically-diverse groups of travelers traveling for a common purpose, the method comprising:
enabling a first application for access to a first GPS device configured to record first location data regarding a physical location of a first user terminal and a first digital calendar for a first user;
enabling a second application for access to a second GPS device configured to record second location data regarding a physical location of a second user terminal and a second digital calendar for a second user;
determining a plurality of first times that the first user is available using first appointments entered in the first digital calendar and a plurality of second times that the second user is available using second appointments entered in the second digital calendar;
determining a first location of the first user terminal from the first GPS device and a second location of the second user terminal from the second GPS device;
reserving a first travel option for the first user departing from a first airport within a predefined first range of the first location at a first time when the first user is available according to the first digital calendar and a second travel option for the second user departing from a second airport within a predefined second range of the second location at a second time when the second user is available according to the second digital calendar, the first travel option and the second travel option arriving in a common location on a same day;
using the first GPS device to determine whether the first user terminal arrived at the first airport on the same day prior to the first time and was subsequently disabled;
using the second GPS device to determine whether the second user terminal arrived at the second airport on the same day prior to the second time and was subsequently disabled;
when the first user terminal did not arrive at the first airport on the same day prior to first time or the first GPS device was not subsequently disabled, booking a new first travel option for the first user departing from the first airport at a different first time when the first user is available according to the first digital calendar and notifying the second user that the first user is traveling according to the new first travel option; and
when the second user terminal did not arrive at the second airport on the same day prior to second time or the second GPS device was not subsequently disabled, booking a new second travel option for the second user departing from the second airport at a different second time when the second user is available according to the second digital calendar and notifying the first user that the second user is traveling according to the new second travel option.

12. The method of claim 11, comprising
accepting, from the first user terminal, a first user input setting the common location and the same day for the second user.

13. The method of claim 11, comprising
storing a database corresponding a plurality of constituents to a plurality of soft constraints, the plurality of constituents including at least two constituents that are assigned different weights, the plurality of soft constraints each including a value between a minimum value and a maximum value, and
using the plurality of soft constraints when determining the first travel option and the second travel option.

14. The method of claim 13, comprising
storing a plurality of hard constraints corresponding to the plurality of constituents, and
using the plurality of soft constraints and the plurality of hard constraints when determining the first travel option and the second travel option.

15. The method of claim 11, comprising
ranking a plurality of first travel options and enabling the first user to select the first travel option via the first application at the first terminal, and
ranking a plurality of second travel options and enabling the second user to select the second travel option via the second application at the second user terminal.

16. The method of claim 15, comprising
causing a first graphical user interface of the first application to display the plurality of first travel options such that the plurality of first travel options are arranged according to respective first travel scores, and
causing a second graphical user interface of the second application to display the plurality of second travel options such that the plurality of second travel options are arranged according to respective second travel scores.

17. The method of claim 11, comprising
causing the first travel option to be entered in the first digital calendar and the second travel option to be entered in the second digital calendar.

18. The method of claim 11, comprising
using the first GPS device to determine whether the first user terminal arrived at the common location and thereafter notifying the second user that the first user arrived at the common location, and
using the second GPS device to determine whether the second user terminal arrived at the common location and thereafter notifying the first user that the second user arrived at the common location.

19. The method of claim 11, comprising
automatically booking the new first travel option upon determining that the first user terminal did not arrive at the first airport on the same day prior to the first time or that the first GPS device was not subsequently disabled.

20. The method of claim 11, comprising
enabling the first user to identify the second user prior to determining the second location of the second user terminal from the second GPS device.
